(19) United States
(12) Patent Application Publication
(10) Pub. No.: US 2003/0225670 A1
(43) Pub. Date: Dec. 4, 2003

(54) Auction style distribution of domain names

(76) Inventor: George J. DeCarlo III, Vancouver, WA (US)

Correspondence Address: KOLISCH HARTWELL, P.C., 520 S.W. YAMHILL STREET, SUITE 200, PORTLAND, OR, 97204, US

(21) Appl. No.: 10/161,087

(22) Filed: May 31, 2002

(51) Int. Cl. G06F 17/60

(52) U.S. Cl. 705/37

(57) ABSTRACT

The present invention provides for the auction style distribution of domain names. Specifically, the present invention provides both methods and systems adapted to monitor domain name registries and/or other resources for imminently available domain names. These domain names are then made available for auction to potential registrants. The auction may take place over a network such as the Internet.

### BACKGROUND OF THE INVENTION

As internet usage continues to expand, ownership of desirable domain names is becoming increasingly important. Domain names must be registered through ICANN accredited domain name registrars. Typically, domain names are registered by providing the user with a searchable database of currently registered domain names. The user queries the database regarding the status of a desired domain name. The user is then notified as to whether or not the desired domain name is already registered. If the domain name is not currently registered, the user may provide information to the domain name registrar, typically a name and address, and an add command is sent. If the domain name is still available when the add command is received by the registry, a response indicating such is sent back to the user and the domain name is registered to the user.

Every day, tens of thousands of previously registered domain names are deleted from various domain name registries due to expiration of their registration. Moreover, as internet traffic increases, new top level domains such as .biz, .info, and the like are created. Both expiration and addition of new top level domains make domain names that were previously unavailable, available to the public. Typically, these domain names are registered in a first come, first served manner. Thus, registration systems such as those described above that depend upon the user searching a database to determine whether or not a specific domain name is available, require a user to be lucky enough or savvy enough to find out that the desired domain name is about to become available and then try to register a newly available domain name at the moment of availability. Moreover, because the registrars typically work on a first come, first served basis, market factors such as desirability do not enter into the distribution process. As such, domain names are not necessarily registered to those users who value them most.

### SUMMARY OF THE INVENTION

In a first embodiment the present invention provides a method for distributing domain names to users. The method includes monitoring domain name registries for imminently available domain names, offering one of the imminently available domain names to users in an auction, determining a highest bidder for the offered domain name, attempting to obtain the offered domain name; and transferring the offered domain name to the highest bidder, if it is obtained.

In another embodiment, the present invention provides a system for distributing domain names to users. The system includes a network and a domain name registration provider. The domain name registration provider includes a notification routine including code for monitoring the availability of domain names via the network, a database maintaining a list of domain names about to become available, and a user interface and associated code for allowing a user to search the domain name registration system database via the network. The domain name registration provider also includes an auction routine including a user interface and associated code for allowing a user to bid on any of the domain names in the domain name registration system database via the network, and a resolve bidding subroutine including code for determining the highest bidder. The domain name registration provider further includes an acquisition routine including code for sending a plurality of add commands to a registry via the network.

The advantages of the present invention will be understood more readily after a consideration of the drawings and the Detailed Description.

### BRIEF DESCRIPTION OF THE DRAWINGS

FIG. 1 is a flowchart depicting a method of distributing domain names to users according to the present invention.

FIG. 2 is a flow chart depicting another method of distributing domain names to users according to the present invention.

FIG. 3 is a flow chart depicting yet another method of distributing domain names to users according to the present invention.

FIG. 4 is a flow chart depicting another method of distributing domain names to users according to the present invention.

FIG. 5 is a diagram illustrating a method of requesting a domain name registration from a domain name registrar according to the present invention.

FIG. 6 is a schematic illustration of apparatus for distributing domain names to users according to the present invention.

FIG. 7 is a schematic illustration of a notification subsystem suitable for use with the apparatus of FIG. 6.

FIG. 8 is a schematic illustration of an auction subsystem suitable for use with the apparatus of FIG. 6.

FIG. 9 is a schematic illustration of an acquisition subsystem suitable for use with the apparatus of FIG. 6.

FIG. 10 is a schematic illustration of a transfer subsystem suitable for use with the apparatus of FIG. 6.

### DETAILED DESCRIPTION AND BEST MODE OF THE INVENTION

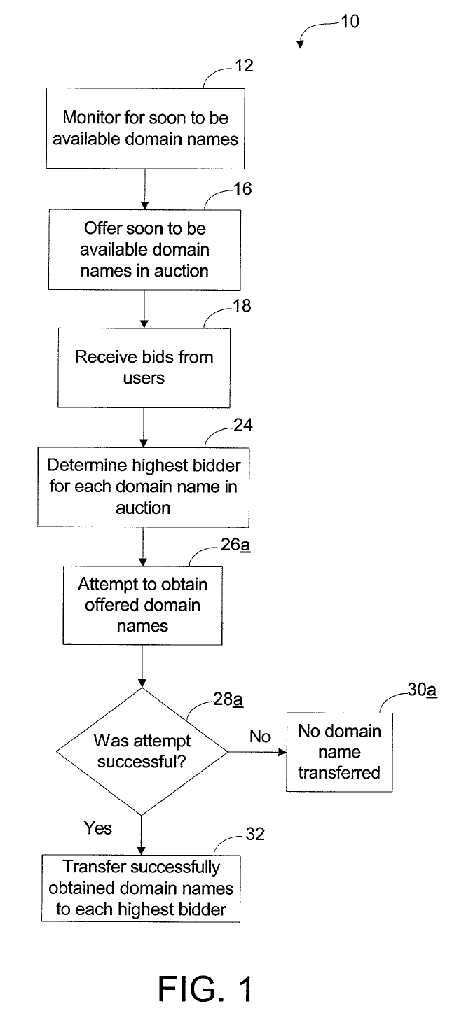

The present invention provides method and apparatus for distributing domain names to potential registrants. FIG. 1 is a flowchart depicting a general method 10 for distributing domain names to potential registrants, or users, according to the present invention. Initially, as shown at 12, one or more domain name registries or alternative resources are monitored to find domain names that will soon be available for registration. An alternative resource may include a user or other entity who suggests or otherwise provides a domain name they know is about to become available. For the purposes of the present invention, receiving information from a user or any other entity regarding a domain name that will soon be available is considered to be part of the monitoring process.

The impending availability of a domain name may be brought about for any number of reasons. For example, a current domain name may become available due to the expiration of a present registration. Alternatively, the new domain name may become available due to the creation of a new top level domain.

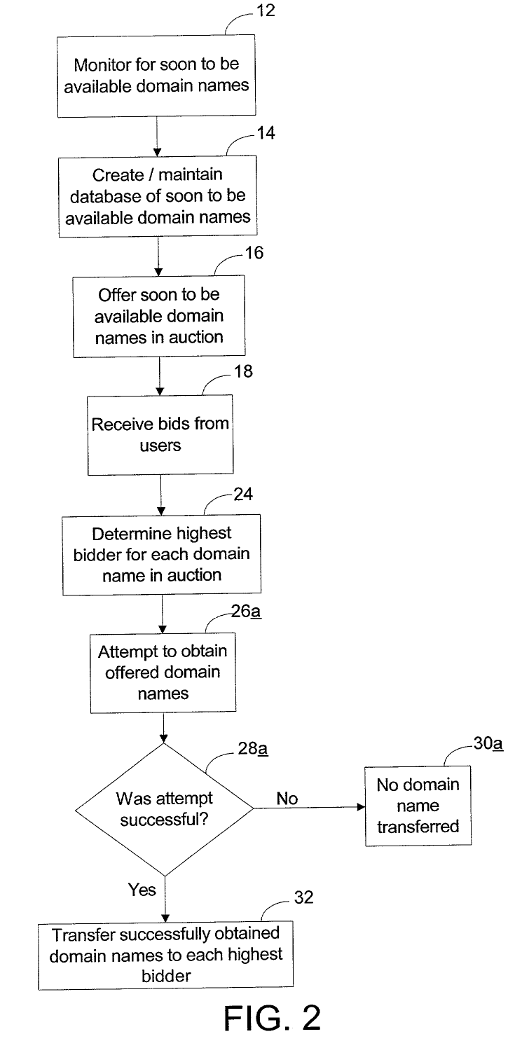

As will be described in further detail below, in one embodiment, the invention provides that the presently described method may be performed via a computer network, such as the internet or world wide web. In such an embodiment, the monitoring of domain name registries may be performed over the network by a processor executing suitable code. Moreover, such monitoring may be performed continuously. For example, continuous monitoring may be performed by the aforementioned processor. As shown in FIG. 2 at 14, the method may include the steps of creating and maintaining a database of the imminently available domain names. As used in this application, the term imminent should not be read to imply that the domain names will be available within any particular time frame, but only that they will be available some time in the future and at a known or predictable time. As such, an imminently available domain name may become available in a matter of minutes, hours, days or weeks. It is presumed that the methods of monitoring and/or database creation will take into account the desired amount of lead time before the domain name is to become available.

For example, if a 10 day lead time is desired, the monitoring method may be configured to identify those domain names that will be available in the next 10 days. As a specific non-limiting illustration, the monitoring method may identify those currently registered domain names for which registration is set to expire in the next 10 days. Moreover, in those embodiments of the present invention in which a database is employed, it may be desirable to maintain only those domain names that will be available in the next 10 days in the database. However, as will be appreciated, the database need not be limited to only those currently registered domain names for which registration is set to expire, but may also identify domain names about to be newly created, for example through the formation of a new top level domain. Of course it will be appreciated that the desired lead time may be a matter of minutes, hours, days, weeks, months, or years, as desired by the particular practitioner of the presently described invention.

Once the database is created, it may be made available to users with browsing and/or searching capabilities. Thus, a user may browse or search the database to find those imminently available domain names that are of interest to the user.

Returning to FIG. 1, the method typically includes offering to users the ability to bid on those domain names that will soon be available for registration in an auction, as shown at 16. Thus, a user may select one or more imminently available domain names that are of interest to the user and then bid on those domain names. The method may include a default minimum bid, for example $25.

Moreover, the method may allow the user to place proxy bids whereby the user's bid will automatically be incrementally increased up to a maximum amount set by the user if the user is outbid by another user. It may be desirable for the amount of the incremental increase to be preset, for example at $1.

Furthermore, the method may provide a mechanism by which users can bid on multiple domain names at the same time.

As will be appreciated, if the method is being practiced over a network connection, the method may allow the user to offer his or her bid over the network. At 18, the method includes receiving bids from one or more users.

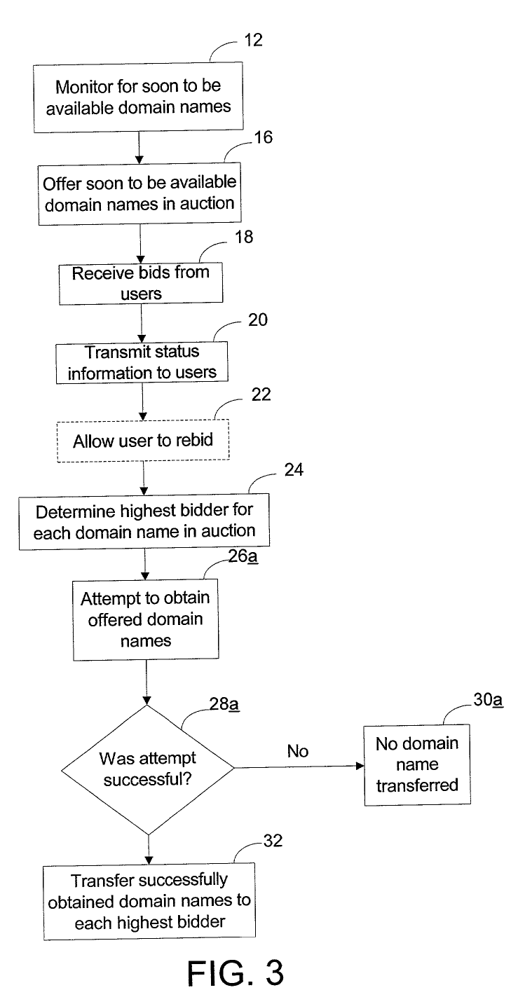

As shown in FIG. 3, the method may include the transmission of status information to users. This status information may include the current bid price, whether the user has been outbid by another bidder, the amount of time left before the auction is closed, and the like. As an option, as shown at 22, the method may allow a user who has been outbid by someone else the opportunity to increase their bid.

Returning to FIG. 1, once all final bids are received and the auction is closed, the method includes determining the highest bidder for each domain name made available in the auction, as shown at 24.

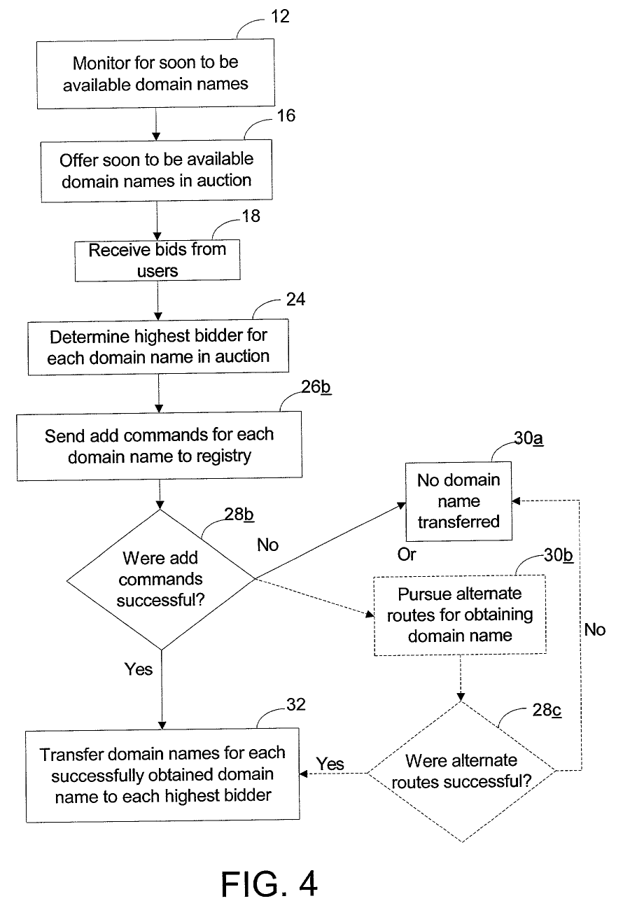

At 26a, the method includes attempting to obtain the offered domain names. For example, if an imminently available domain name is available through a domain name registry, the registry may use a queue-based system and register the domain name to the first inquirer. In such a situation, the method may include entering the queue, for example by sending an add command to the appropriate registry as shown at 26b, in FIG. 4.

As will be appreciated, the step of attempting to obtain the domain names need not necessarily chronologically follow the step of determining the highest bidder for each domain name, these steps may take place simultaneously. Alternatively, the step of attempting to obtain the domain names may take place while users are still placing bids, or even before any bids are placed.

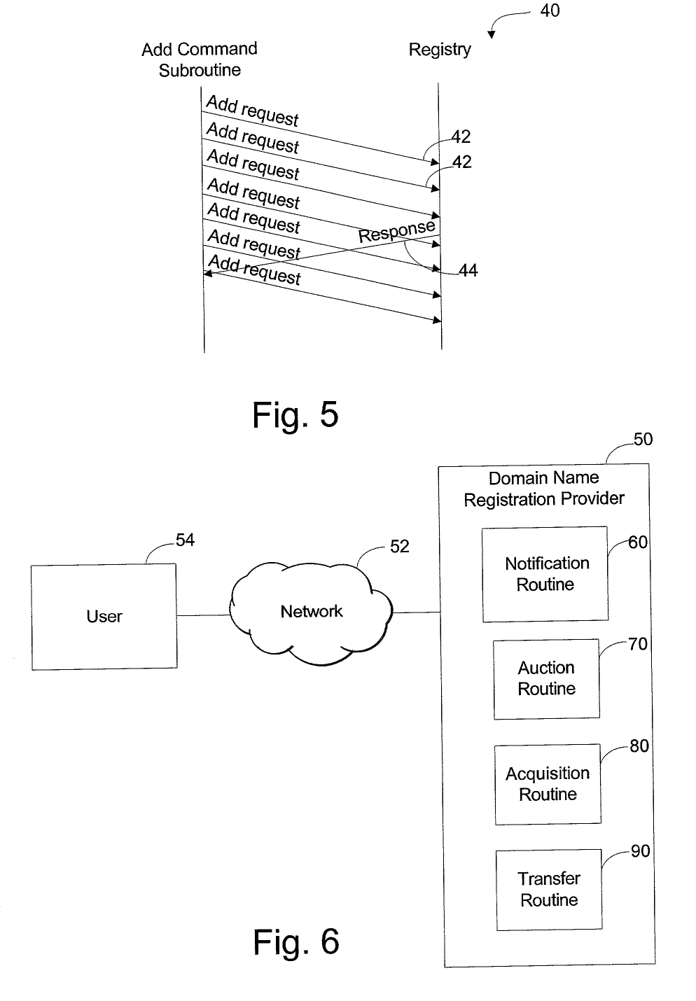

FIG. 5 is a diagram illustrating a method 40 for requesting a domain name registration from a domain name registry that may be implemented by the present invention. As shown, the present invention provides a method whereby a plurality of add commands 42 are sent to the registry. In some cases, the add commands may be sent continuously, in essence flooding the registry with add commands. Thus, the lag time between requests is significantly reduced, if not eliminated. This flood of commands increases the probability that the desired domain name will be granted to the practitioner of the present invention. The method may be adapted such that once a response 44 is received, the add commands may be halted.

Returning to FIG. 1, at 28a, the method involves determining whether the attempt to obtain the offered domain names was successful. If not, no domain name names are transferred, as shown in at 30a. In some embodiments, the method may involve not charging the user if no domain name is transferred. However, if the attempt to obtain the offered domain name was successful, as shown at 32, then each successfully obtained domain name is transferred to the highest bidder for that domain name.

As shown in FIG. 4, when an initial attempt to obtain a domain name by sending one or more add commands to a registry is unsuccessful, the method may provide for the pursuit of alternate routes, as shown at 30b. For example, the method may provide for the solicitation of a recent registrant of a domain name, with the bid price from the highest bidder. Upon determination that the alternate method was successful, as shown at 28c, the successfully obtained domain name may then be transferred to the highest bidder.

FIG. 6 is a schematic illustration of a system for distributing domain names to users according to one embodiment of the present invention. As shown, system 50 includes a network 52, which may connect a user 54 to a domain name registration provider 56. The domain name registration provider may include one or more computer code routines that may be executed by one or more processors. These routines may include a notification routine 60, an auction routine 70, an acquisition routine 80, and a transfer routine 90. For the sake of clarity, these routines and any subroutines are described as separate routines based on function, however, it should be appreciated that one or more of these routines may be combined into a single routine, divided into additional routines, or arranged in any convenient manner in order to perform the desired function. Moreover, it should be appreciated that not all of the above functions need be performed automatically, or by a computer. For example, as already previously described, some methods of acquiring a domain name may involve contacting the current registrant. This may be performed through personal contact, rather than through an automated computer process. Furthermore, transference of the domain name to the highest bidder may be conducted manually or by a computer. In addition, when a function is performed by a computer, it may be performed automatically, that is without the requirement of a user-inputted command, or upon transmission of a user command.

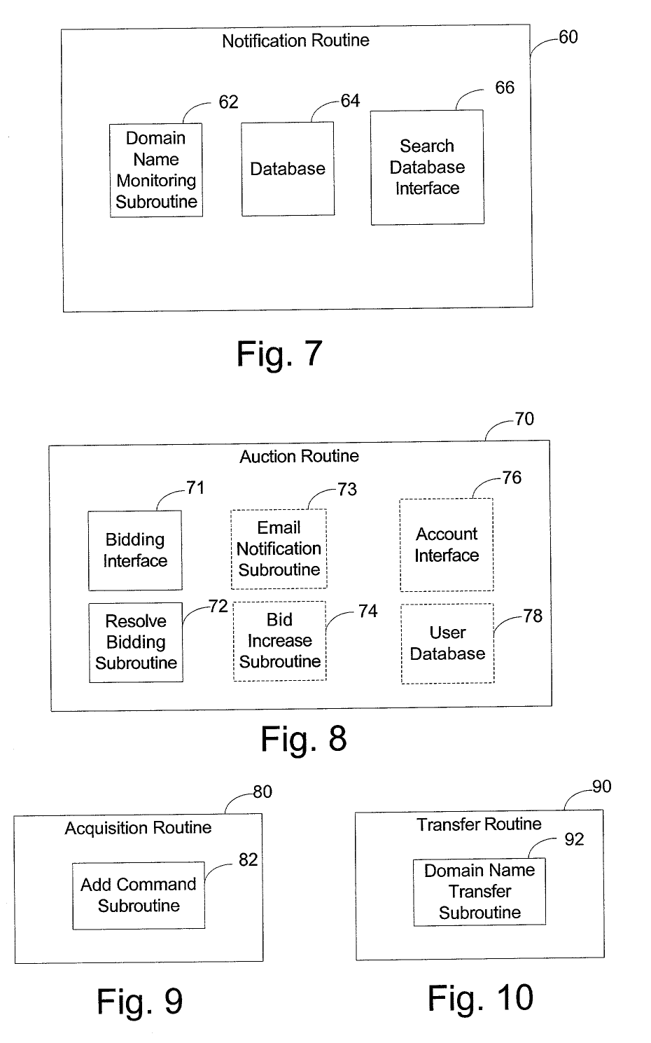

FIG. 7 is a schematic illustration of a notification routine 60 according to the present invention. Notification routine 60 is responsible for identifying imminently available domain names and providing notice of them to the domain name registration provider. The notification routine may include a domain name monitoring subroutine 62 adapted to monitor and identify those domain names that are imminently available, as described above. This monitoring may be continuous or periodic and may take place automatically or require an initiation command.

As stated above, the present invention may include a database of imminently available domain names. The maintenance of database 64 may be part of the responsibilities of notification routine 60. Moreover, notification routine 60 may include a user interface 66 adapted to allow users to search or browse database 64 via a network connection, as described above.

FIG. 8 is a schematic illustration of an auction routine 70 according to the present invention. The auction routine is responsible for the auctioning of imminently available domain names. Auction routine 70 may include a user interface 71, which enables users to place their bids via a network connection, as described above. Auction routine 70 may further include a resolve bidding subroutine 72, which is adapted to collect bids from all users and determine the highest bidder. Optionally, the auction routine may include an email subroutine 73, which may be adapted to deliver status information to users via email and a bid increase subroutine 74, which may allow users who have been overbid to increase their bid amount during the auction.

Auction routine 70 may further include a user account interface 76 adapted to allow the user to input and store information personal to the user in user database 78. This information may include email address, desired domain names, and/or the type of information needed to register a domain names, such as name and address, and the like.

FIG. 9 is a schematic illustration of acquisition routine 80. The acquisition routine is responsible for attempting to obtain the imminently available domain names. The acquisition routine may include an add command subroutine 82, such as that described in reference to FIG. 5.

FIG. 10 is a schematic illustration of transfer routine 90. Transfer routine 90 is responsible for transferring an acquired domain name to the highest bidder. As such, transfer routine 90 may include a domain name transfer subroutine 92. As previously described, transference of the domain name to the highest bidder may take place automatically or may require an initiation command.

The subject matter of the inventions includes all novel and non-obvious combinations and subcombinations of the various elements, features, functions and/or properties disclosed herein. Similarly, where the disclosure recites “a” or “a first” element or the equivalent thereof, such claims should be understood to include incorporation of one or more such elements, neither requiring nor excluding two or more such elements.

What is claimed is:

1. A method for distributing domain names to users comprising:
monitoring for imminently available domain names;
offering one of the imminently available domain names to users in an auction;
determining a highest bidder for the offered domain name;
attempting to obtain the offered domain name; and
transferring the offered domain name to the highest bidder, if it is obtained.

2. The method of claim 1 wherein at least one of the imminently available domain names is about to become available because its registration is about to expire.

3. The method of claim 1 wherein at least one of the imminently available domain names is about to become available because a new top level domain is about to be introduced.

4. The method of claim 1 wherein the monitoring is performed by computer code operating on a processor.

5. The method of claim 4 wherein the monitoring is performed continuously.

6. The method of claim 1 further comprising the step of maintaining a database of the imminently available domain names.

7. The method of claim 6 wherein the step of offering one of the imminently available domain names for auction includes providing access to the database via a network.

8. The method of claim 7 wherein the step of offering one of the imminently available domain names for auction further includes receiving users' bids for the offered domain name via the network.

9. The method of claim 8 wherein the step of offering one of the imminently available domain names for auction further includes transmitting personalized status information regarding each of the users' bids to each the users via the network.

10. The method of claim 9 wherein the personalized status information includes information regarding whether a particular user has been outbid by another user.

11. The method of claim 10 wherein the step of offering one of the imminently available domain names for auction further includes offering a user who has been outbid by another user the opportunity to increase his or her current bid.

12. The method of claim 1 wherein the step of attempting to obtain the offered domain name is performed by computer code operating on a processor.

13. The method of claim 12 wherein the computer code includes instructions to send a plurality of add commands to a registry.

14. The method of claim 13 wherein the plurality of add commands are sent to the registry continuously.

14. A system for distributing domain names to users comprising:
a network; and
a domain name registration provider including:
a notification routine including:
code for monitoring the availability of domain names via the network;
a database maintaining a list of imminently available domain names; and
a user interface and associated code for allowing a user to search the domain name registration system database via the network;
an auction routine including:
a user interface and associated code for allowing a user to bid on any of the domain names in the domain name registration system database via the network;
a resolve bidding subroutine including code for determining the highest bidder; and
an acquisition routine including code for sending a plurality of add commands to a registry via the network, wherein each successive add command is sent without waiting for a response to a prior command.

15. The system of claim 2 wherein the domain name registration provider further includes a domain name transferring routine including code for transferring an acquired domain name to the highest bidder.

16. The system of claim 2 wherein the auction routine further includes a user interface and associated code to allow a user to create and store an account including personal information regarding the user.

17. The system of claim 16 wherein the personal information includes an email address for the user.

18. The system of claim 17 wherein the auction routine further includes code for generating and sending information regarding the user's bid to the email address.

19. The system of claim 18 wherein the information includes whether the user has been outbid by another user.

20. The system of claim 19 wherein the auction routine further includes a user interface and associated code to allow the user to increase his or her bid, if desired.
